(19) United States
(12) Patent Application Publication
(10) Pub. No.: US 2017/0240148 A1
(43) Pub. Date: Aug. 24, 2017

(54) ELECTRIC BRAKE DEVICE

(71) Applicant: MITSUBISHI JIDOSHA KOGYO KABUSHIKI KAISHA, Tokyo (JP)

(72) Inventors: Haruo KOTERA, Tokyo (JP); Hiromitsu TOYOTA, Tokyo (JP)

(73) Assignee: MITSUBISHI JIDOSHA KOGYO KABUSHIKI KAISHA, Tokyo (JP)

(21) Appl. No.: 15/515,505

(22) PCT Filed: May 10, 2016
(86) PCT No.: PCT/JP2016/063798

§ 371 Date: Mar. 29, 2017

(30) Foreign Application Priority Data
Jul. 2, 2015 (JP) 2015-133444

(51) Int. Cl. B60T 8/17; B60T 1/06; F16D 65/22; B60T 13/74; F16D 65/18

(52) U.S. Cl. CPC B60T 8/17; B60T 13/741; F16D 65/18; F16D 65/22; B60T 1/065; B60T 1/067; B60T 2270/414; B60T 2270/402; F16D 2121/24

(57) ABSTRACT

An electric brake device has at least three control units: a front-left wheel control unit for controlling a front-left wheel brake mechanism, a front-right wheel control unit for controlling a front-right wheel brake mechanism, and a rear-left/right wheel control unit for controlling a rear-left wheel brake mechanism and a rear-right wheel brake mechanism. Each of the brake mechanisms has a friction-receiving member that rotates together with the wheel, and a friction-applying member that moves while being powered by an electric actuator, and generates the braking force by pressing the friction-applying member against the friction-receiving member.

### CROSS REFERENCE TO RELATED APPLICATION

This application is the National Phase of PCT International Application No. PCT/JP2016/063798, filed on May 10, 2016, which claims priority under 35 U.S.C. 119(a) to Patent Application No. 2015-133444, filed in Japan on Jul. 2, 2015, all of which are hereby expressly incorporated by reference into the present application.

### TECHNICAL FIELD

This disclosure relates to an electric brake device having a friction-receiving member that rotates together with a wheel; and a friction-applying member that moves while being powered by an electric actuator, and obtains the braking force by pressing the friction-applying member against the friction-receiving member.

### BACKGROUND ART

In recent years, as an alternative for the conventional hydraulic brake, there has been developed an electric brake device designed to obtain braking force by pressing a friction-applying member, such as brake pad, against a friction-receiving member such as brake disk, with the aid of an electric actuator.

The brake device is a critical mechanism of vehicles, and employs a redundant system by which the vehicles can safely stop even in case of brake failure.

For example, Patent Literature 1 below discloses an electrically controlled brake system that includes a brake for limiting rotation of wheels, a power unit, and a brake control unit for controlling the operational state of the brake by controlling electric energy supplied from the power unit; the brake system further includes, disposed between the power source and the brake control unit, a switching device that performs switching from a connected state to a disconnected state in association with braking operation of a brake operating member; the brake control unit includes a switchover unit that toggles between a coupled mode in which the operation of a mechanical brake that operates in association with motion of a brake operating member is coupled to the brake operating member, and a decoupled mode in which the operation is decoupled from the brake operating member, and a switchover unit control unit that performs, in case of failure of the electrically controlled brake system, switching from the decoupled mode to the coupled mode.

### CITATION LIST

### Patent Literature

Patent Literature 1: JP-A-2000-225935

### Technical Problem

The above-described prior art is designed to obtain braking force, in case of failure of the electrically controlled brake system, by activating the mechanical brake. There is however a need for providing the mechanical brake in addition to an electrically controlled brake system, posing an issue of increasing the vehicle cost.

In addition, the above-described prior art has described that four control units are provided for four wheel braking mechanisms, but has not described a system that can control four wheel braking mechanisms with three or less control units, leaving a room for further improvement.

This disclosure, made in consideration of the above-described circumstances, is to improve convenience of the electric brake device.

### Solution to Problem

In pursuit of achieving the above-described object, according to one embodiment, there is provided an electric brake device for a vehicle that has a first wheel pair composed of a first wheel and a second wheel arranged leaving a space in between in a width direction of the vehicle, and a second wheel pair composed of a third wheel and a fourth wheel arranged leaving a space in between in the width direction, and arranged leaving a space from the first wheel pair in a length direction of the vehicle, the electric brake device including at least three control units: a first control unit that controls a first brake mechanism for braking the first wheel; a second control unit that controls a second brake mechanism for braking the second wheel; and a third control unit that controls a third brake mechanism for braking the third wheel, and a fourth brake mechanism for braking the fourth wheel.

According to one embodiment, there is provided such electric brake device, wherein, in case of braking malfunction at any one of the first wheel, the second wheel, the third wheel and the fourth wheel, the control unit reduces braking force for a wheel positioned opposite to the defective wheel both in the width direction and the length direction.

According to one embodiment, there is provided such electric brake device, wherein, in case of braking malfunction at any two or more of the first wheel, the second wheel, the third wheel and the fourth wheel, the control unit controls braking forces in a manner such that the braking forces of the first wheel and the second wheel be balanced, and the braking forces of the third wheel and the fourth wheel be balanced.

According to one embodiment, there is provided such electric brake device, wherein, in case of failure of either the first control unit or the second control unit, the third control unit reduces braking force of either the third brake mechanism or the fourth brake mechanism positioned opposite to such one control unit in the width direction, and increases braking force of either the third brake mechanism or the fourth brake mechanism positioned on the same side with such one control unit in the width direction; and the other one of the first control unit and the second control unit increases braking force of the brake mechanism positioned opposite to such one control unit in the width direction.

According to one embodiment, there is provided such electric brake device, wherein, in case of failure of the third control unit, the first control unit and the second control unit increase braking forces of the first brake mechanism and the second brake mechanism, respectively.

According to one embodiment, there is provided such electric brake device, further including a parking brake mechanism which applies braking force to each of the third wheel and the fourth wheel; and a parking control unit that controls the parking brake mechanism, wherein, in case of failure of the third control unit, the parking control unit activates the parking brake mechanism to generate braking force for the third wheel and the fourth wheel.

According to one embodiment, there is provided such electric brake device, wherein, in case of failure of the first control unit and the second control unit, the third control unit individually increases braking force of the third brake mechanism and the fourth brake mechanism.

According to one embodiment, there is provided such electric brake device, further including a parking brake mechanism that applies braking force to each of the third wheel and the fourth wheel; and a parking control unit that controls the parking brake mechanism, wherein, in case of failure of either the first control unit or the second control unit, and also of the third control unit, the other one of the first control unit and the second control unit reduces braking force of the brake mechanism positioned opposite to such one control unit in the width direction, and the parking control unit activates the parking brake mechanism to generate braking force for the third wheel and the fourth wheel.

According to one embodiment, there is provided such electric brake device,

wherein each of the brake mechanisms includes a friction-receiving member that rotates together with the wheel; and a friction-applying member that moves while being powered by an electric actuator, and obtains the braking force by pressing the friction-applying member against the friction-receiving member.

According to one embodiment, there is provided such electric brake device, wherein each of the brake mechanisms includes a brake disk that rotates together with the wheel, and an electric caliper that has a brake pad movable between the pressing position and the non-pressing position relative to the brake disk by aid of the electric actuator.

According to one embodiment, there is provided such electric brake device, wherein the third brake mechanism and the fourth brake mechanism also function as the parking brake mechanism, and the parking control unit activates the parking brake by moving the brake pads of the third brake mechanism and the fourth brake mechanism to the pressing position relative to the brake disk.

According to one embodiment, there is provided such electric brake device, wherein the parking brake mechanism includes a brake drum that is provided in a hat positioned at the center of the brake disk of each of the third brake mechanism and the fourth brake mechanism, and is rotatable together with the wheel; and a brake shoe provided in each of the brake drums and movable between the pressing position and the non-pressing position relative to each brake drum by aid of an electric actuator for parking, and the parking control unit activates the parking brake by moving the brake shoe of the parking brake mechanism to the pressing position relative to the brake drum.

According to one embodiment, there is provided such electric brake device, wherein the parking brake mechanism includes a brake drum that is provided in a hat positioned at the center of the brake disk of each of the third brake mechanism and the fourth brake mechanism, and is rotatable together with the wheel; and a brake shoe provided in each of the brake drum and movable between the pressing position and the non-pressing position relative to each brake drum by aid of a linear motion electric actuator, and the parking control unit activates the parking brake by moving the brake shoe of the parking brake mechanism to the pressing position relative to the brake drum.

According to one embodiment, there is provided such electric brake device, wherein each of the brake mechanisms is connected to a main battery and a backup battery that serve as power sources for controlling and activating the brake mechanisms, and, in case of main battery failure, the power source for each brake mechanism is switched to the backup battery.

According to one embodiment, there is provided such electric brake device,

wherein the first wheel is the front-left wheel, the second wheel is the front-right wheel, the third wheel is the rear-left wheel, and the fourth wheel is the rear-right wheel; the first brake mechanism is the front-left wheel brake mechanism, the second brake mechanism is the front-right wheel brake mechanism, the third brake mechanism is the rear-left wheel brake mechanism, and the fourth brake mechanism is the rear-right wheel brake mechanism; and the first control unit is the front-left wheel control unit, the second control unit is the front-right wheel control unit, and the third control unit is the rear-left/right wheel control unit.

### Advantageous Effects of Invention

According to the embodiment, four brake mechanism can be controlled by three control units, posing an advantage of reducing the quantity of parts for the electric brake device, and reducing the vehicle cost, wherein in case of failure of the third control unit, the parking brake mechanism is activated to produce the braking force for the third wheel and the fourth wheel, posing an advantage of obtaining a higher level of braking force.

According to the embodiment, in case of malfunction and braking failure at any one wheel, the braking force is reduced for a wheel positioned opposite to the defective wheel both in the width direction and the length direction, that is, both in the front-rear direction and the crosswise direction, posing an advantage of balancing the braking force in the vehicle-width direction.

According to the embodiment, in case of braking malfunction at any two or more wheels, the braking force is controlled so as to be balanced between braking forces of the wheels composing the individual wheel pairs, posing an advantage of balancing the braking force in the vehicle-width direction, and stabilizing the vehicle posture during braking.

According to the embodiment, when either the first control unit or the second control unit went into failure to disable braking, the braking force of the brake mechanism positioned opposite to the defective control unit both in the width direction and in the length direction is reduced; the braking force of the brake mechanism positioned on the same side in the width direction and on the opposite side in the length direction with respect to the defective control unit is increased; and the braking force of the brake mechanism positioned on the opposite side in the width direction and on the same side in the length direction with respect to the defective control unit is increased, posing an advantage of balancing the braking force in the vehicle-width direction, and stabilizing the vehicle posture during braking.

According to the embodiment, in case of failure of the third control unit, the braking forces of the first control unit and the second control unit are individually increased, posing an advantage of achieving a braking force nearly equal to that before the failure, while balancing the braking force in the vehicle-width direction.

According to the embodiment, in case of failure of the first control unit and the second control unit, the braking forces of the third brake mechanism and the fourth brake mechanism are individually increased, posing an advantage of achieving a braking force nearly equal to that before the failure, while balancing the braking force in the vehicle-width direction.

According to the embodiment, in case of failure of either the first control unit or the second control unit, and also of the third control unit, the braking force of the brake mechanism positioned on the opposite side in the width direction and on the same side in the length direction with respect to the defective control unit is reduced; and the parking brake mechanism generates the braking force for the third wheel and the fourth wheel, posing an advantage of balancing the braking force in the vehicle-width direction, and stabilizing the vehicle posture during braking.

According to the embodiment, each of the brake mechanisms obtains the braking force by pressing, with the aid of the actuator, the friction-applying member against the friction-receiving member that rotates together with the wheel, posing an advantage of improving responsiveness to the brake operation as compared with the conventional hydraulic brake, and enabling various modes of brake operation adopted to the vehicle conditions.

According to the embodiment, a disk brake system with a high heat radiation performance is built by employing a brake disk as the friction-receiving member, and a brake pad as the friction-applying member, posing an advantage of improving durability of the brake mechanism.

According to the embodiment, the third brake mechanism and the fourth brake mechanism also function as the parking brake mechanism, posing an advantage of reducing vehicle weight and simplifying vehicle configuration, as compared with the case where a dedicated parking brake mechanism is provided.

According to the embodiment, the parking brake mechanism is composed by providing a drum brake system at the center of the brake disk, posing an advantage of relieving the load of the individual brake mechanisms, as compared with the case where the third brake mechanism and the fourth brake mechanism also function as the parking brake mechanism.

According to the embodiment, the parking brake mechanism is configured by providing an additional brake system for the parking brake at the center of the brake disk, posing an advantage of relieving the load of the individual brake mechanisms, as compared with the case where the third brake mechanism and the fourth brake mechanism also function as the parking brake mechanism.

According to the embodiment, there are provided two batteries for supplying power to each brake mechanism, making it possible to allowing a sub-battery to activate the brake mechanism even in case of failure of the main battery, posing an advantage of improving redundancy of the brake mechanism.

According to the embodiment, the control units are provided one by one to the front-left wheel brake mechanism and the front-right wheel brake mechanism, and a single control unit is allocated to the left and right brake mechanisms for rear wheels, so that even if one control unit should go into failure, the residual brake mechanism for the front wheels remains controllable, posing an advantage of enhancing redundancy of the front wheel brake having a higher importance in braking.

### BRIEF DESCRIPTION OF DRAWINGS

FIG. 1 is an explanatory drawing illustrating a configuration of an electric brake device 10 according to an embodiment.

FIG. 2 is an explanatory drawing illustrating an exemplary configuration of a parking brake in the electric brake device 10.

FIG. 3 is an explanatory drawing illustrating an exemplary schematic configuration of a control unit.

FIG. 4 is an explanatory drawing illustrating changes in braking force in case of control unit failure.

FIG. 5 is an explanatory drawing illustrating changes in braking force in case of control unit failure.

FIG. 6 is an explanatory drawing illustrating changes in braking force in case of control unit failure.

FIG. 7 is an explanatory drawing illustrating changes in braking force in case of control unit failure.

### DESCRIPTION OF EMBODIMENTS

Preferred embodiments of the electric brake device of this disclosure will be detailed below, referring to the attached drawings.

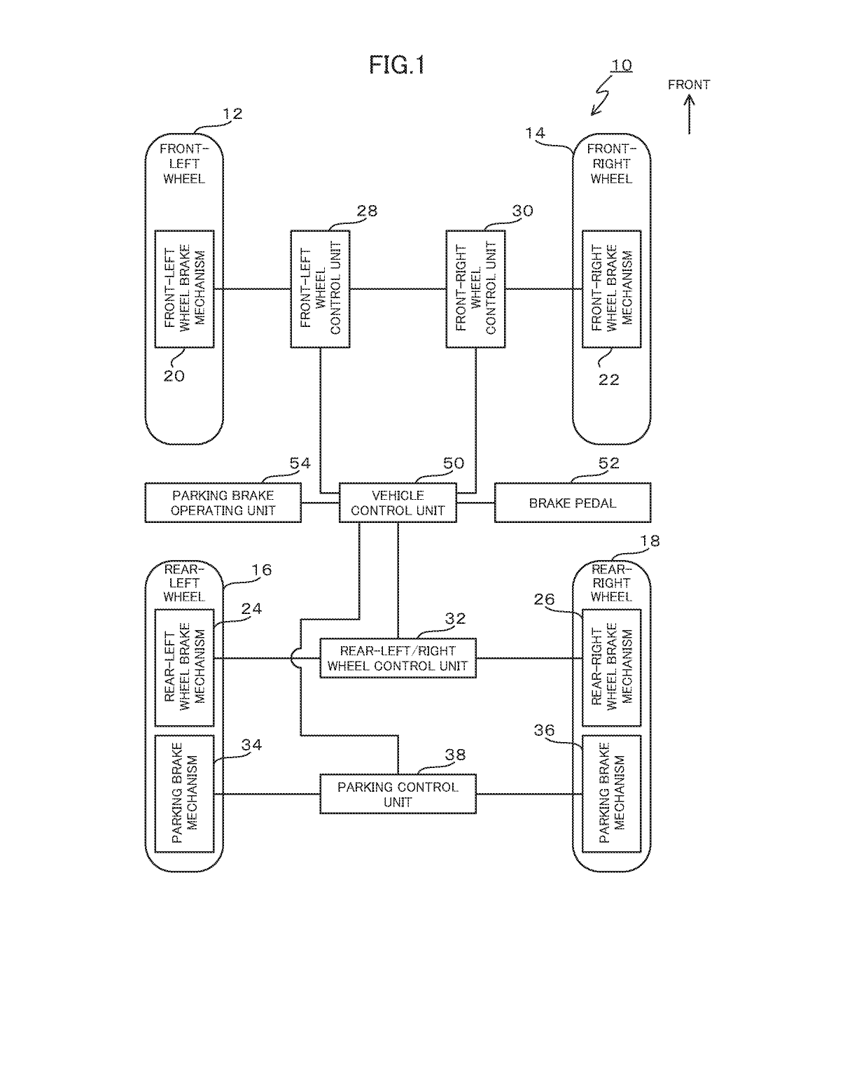

FIG. 1 is an explanatory drawing illustrating a configuration of an electric brake device 10 according to an embodiment.

The electric brake device 10 is configured to contain front, rear, left and right wheels 12, 14, 16, 18; brake mechanisms 20, 22, 24, 26, 34, 36 respectively provided to the wheels; control units 28, 30, 32, 38, 50; and operating units 52, 54.

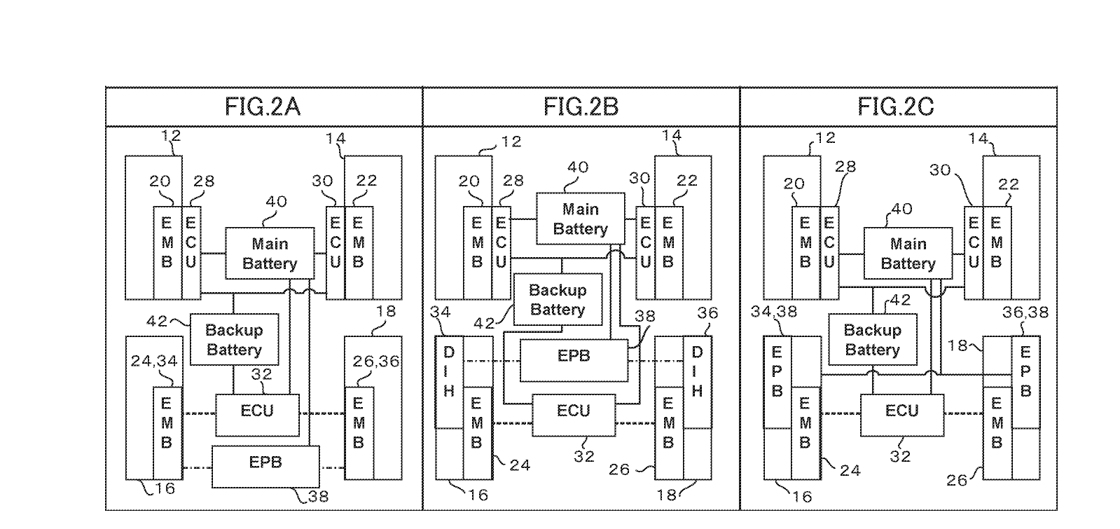

Note that, in addition to the configuration illustrated in FIG. 1, the electric brake device 10 also has a main battery 40 and a backup battery 42 (see FIG. 2), but not shown in FIG. 1.

In more detail, the wheels 12, 14, 16, 18 are the front-left wheel 12, the front-right wheel 14, the rear-left wheel 16, and the rear-right wheel 18. There are provided the front-left wheel brake mechanism 20 to the front-left wheel 12; the front-right wheel brake mechanism 22 to the front-right wheel 14; the rear-left wheel brake mechanism 24 to the rear-left wheel 16; and the rear-right wheel brake mechanism 26 to the rear-right wheel 18, respectively, making it possible to brake the respective wheels.

The individual brake mechanisms 20, 22, 24, 26 configure service brakes, and are respectively provided with control units 28, 30, 32.

Among them, the front-left wheel brake mechanism 20 is controlled by the front-left wheel control unit 28, the front-right wheel brake mechanism 22 by the front-right wheel control unit 30, and the rear-left wheel brake mechanism 24 and the rear-right wheel brake mechanism 26 by the rear-left/right wheel control unit 32, respectively.

The parking control unit 38 controls the parking brake mechanisms 34, 36.

The individual control units 28, 30, 32, 38 are connected to the vehicle control unit 50 that takes part in main control of the vehicle.

The vehicle control unit 50 is connected to a brake pedal (service brake operating unit) 52 and a parking brake operating unit 54, and outputs, when the brake pedal 52 or the parking brake operating unit 54 is operated, a control signal that directs the individual control units 28, 30, 32, 38 to activate the brake.

The vehicle control unit 50 also monitors the operating status of the individual control units 28, 30, 32, 38, and outputs, when any of the control units 28, 30, 32, 38 should go into failure, a control signal that notifies other control units of the failure.

Note that, in place of notifying the failure of the control units 28, 30, 32, 38 by way of the vehicle control unit 50, the individual control units 28, 30, 32, 38 may be connected directly so as to allow them to monitor each other.

Each of the brake mechanisms 20, 22, 24, 26 is an electric brake mechanism (electro-mechanical brake: EMB) that has a friction-receiving member that rotates together with a wheel, and a friction-applying member that moves while being powered by an electric actuator, and obtains the braking force by pressing the friction-applying member against the friction-receiving member.

In more detail, each of the brake mechanisms 20, 22, 24, 26 has a brake disk (friction-receiving member) that rotates together with the wheel, and an electric caliper that has a brake pad movable between the pressing position and the non-pressing position relative to the brake disk by aid of the electric actuator.

In the normal state (non-braking state), the brake pad is positioned at the non-pressing position away from the brake disk. When braking, the control units 28, 30, 32 activate the electric actuator to move the brake pad to the pressing position where the pad comes into contact with the brake disk, thereby kinetic energy of the wheels is converted into thermal energy, and the vehicle is slowed down to a desired speed.

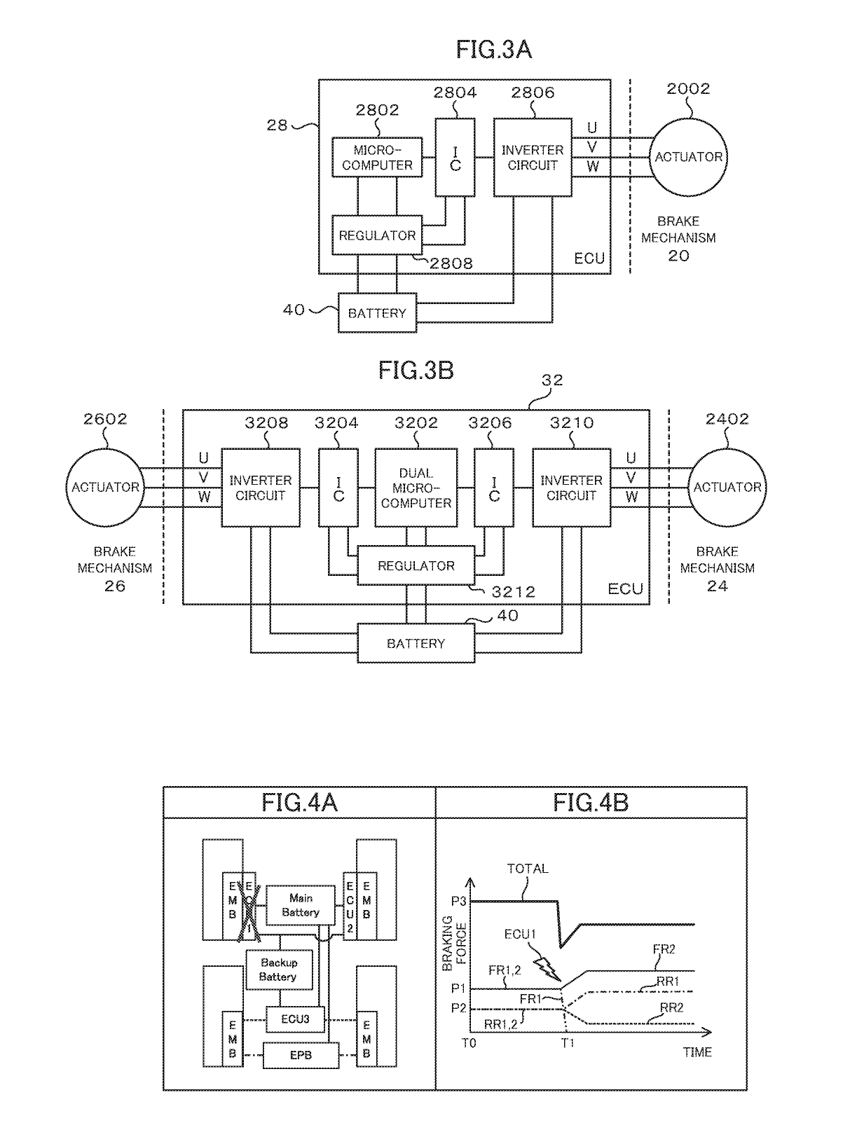

FIG. 3 is an explanatory drawing illustrating an exemplary schematic configuration of the control unit, wherein FIG. 3A illustrates the control unit that controls one brake mechanism, such as the front-left wheel control unit 28 (or the front-right wheel control unit 30), and FIG. 3B illustrates the control unit that controls two brake mechanisms, such as the rear-left/right wheel control unit 32.

As illustrated in FIG. 3A, the front-left wheel control unit 28 is configured to contain a microcomputer 2802, an integrated circuit (IC) 2804, and a bridge (inverter) circuit 2806. A power source regulator 2808 and the bridge circuit 2806 are connected to a main battery 40.

The microcomputer 2802 is connected to the vehicle control unit 50 (not illustrated in FIG. 3), and, when a brake activation instruction is issued from the vehicle control unit 50, activates the bridge circuit 2806 to convert electric power of the main battery 40 into three-phase AC power, and supplies the power to the electric actuator 2002 of the brake mechanism (the front-left wheel brake mechanism 20 in FIG. 3A) to thereby activate the electric actuator 2002. In short, the front-left wheel control unit 28 contains a power source circuit of the front-left wheel brake mechanism 20.

As illustrated in FIG. 3B, the rear-left/right wheel control unit 32 is configured to contain a dual microcomputer 3202, two integrated circuits 3204, 3206, two bridge circuits 3208, 3210, and a power source regulator 3212. A power source regulator 3212 and the bridge circuits 3208, 3210 are individually connected to the main battery 40.

The dual microcomputer 3202 is connected to the vehicle control unit 50, and, when a brake activation instruction was issued from the vehicle control unit 50, activates the bridge circuits 3208, 3210 to convert electric power of the main battery 40 into three-phase AC power, and supplies the power to the electric actuators 2402, 2602 of the brake mechanism (the rear-left wheel brake mechanism 24 and the rear-right wheel brake mechanism 26 in FIG. 3B) to thereby activate the electric actuators 2402, 2602.

Since operations of the bridge circuits 3208, 3210 are controllable independently, so that the individual electric actuators 2402, 2602 (rear-left wheel brake mechanism 24 and rear-right wheel brake mechanism 26) may be put into operation independently.

Since the electric brake mechanism controls operations of the brake mechanism by electric signals, so that the operations of the brake mechanism may be controlled finely depending on situations, thus making it no more necessary to use hydraulic piping, and making it possible to considerably reduce the vehicle weight.

As illustrated in FIG. 2, the individual brake mechanisms 20, 22, 24, 26 in this embodiment are connected to the main battery 40 and the backup battery 42, allowing that if the main battery 40 should go into failure, the supply source of power towards the individual brake mechanisms 20, 22, 24, 26 is switched to the backup battery 42. This improves availability of the brake mechanisms 20, 22, 24, 26.

Referring now back to FIG. 1, the rear-left wheel 16 and the rear-right wheel 18 are further provided with the parking brake mechanisms 34, 36, respectively. The parking brake mechanisms 34, 36 are mainly used for preventing parked vehicles from moving.

The parking brake mechanisms 34, 36 are controlled by the parking control unit 38.

In this embodiment, each of the parking brake mechanisms 34, 36 is an electric parking brake (EPB), and may be configured in various ways.

FIG. 2 is an explanatory drawing illustrating an exemplary configuration of the parking brake in the electric brake device 10.

In FIG. 2, EMB 20 corresponds to the front-left wheel brake mechanism 20, EMB 22 to the front-right wheel brake mechanism 22, EMB 24 to the rear-left wheel brake mechanism 24, and EMB 26 to the rear-right wheel brake mechanism 26.

ECU 28 corresponds to the front-left wheel control unit 28, ECU 30 to the front-right wheel control unit 30, and ECU 32 to the rear-left/right wheel control unit 32.

EPB 38 corresponds to the parking control unit 38.

In the design illustrated in FIG. 2A, the rear-left wheel brake mechanism 24 and the rear-right wheel brake mechanism 26 also function as the parking brake mechanisms 34, 36, respectively.

More specifically, when using the parking brake, the parking control unit 38 activates the electric actuators of the rear-left wheel brake mechanism 24 and the rear-right wheel brake mechanism 26, the brake pads then move to the pressing position relative to the brake disk, to thereby apply braking force to the rear-left/right wheels 16, 18.

With such configuration, a brake mechanism solely for parking is no more necessary, and the vehicle weight may be reduced.

FIG. 2B illustrates an exemplary configuration of the parking brake mechanisms 34, 36 based on the drum-in-hat (DIH) system, in which a brake drum is disposed in the brake disk of the rear-left wheel brake mechanism 24 and the rear-right wheel brake mechanism 26.

More specifically, the parking brake mechanisms 34, 36 have brake drums respectively disposed in the hats positioned at the center of the brake disks of the rear-left wheel brake mechanism 24 and the rear-right wheel brake mechanism 26, and rotate together with the wheels; and brake shoes provided inside the individual brake drums, and movable between the pressing position and the non-pressing position relative to the brake drums while being powered by the electric actuators for parking.

In the normal state (non-braking state for parking), each brake shoe is energized by a spring towards the inner circumference of the brake drum, and is kept at the non-pressing position away from the brake drum. To the brake shoe, there is also attached a brake shoe lever whose one end is attached to the brake shoe in a swingable manner, and whose other end has a wire attached thereto.

When the wire is pulled (wound) by the electric actuator for parking, the brake shoe lever swings, the brake shoe moves towards the outer circumference of the brake drum against the energizing force of the spring, and positions itself at the pressing position relative to the brake drum.

As described above, when operating the parking brake, the parking control unit 38 activates the electric actuator for parking, moves the brake shoes of the parking brake mechanisms 34, 36 to the pressing position relative to the brake drum, to thereby apply the braking force to the rear-left/right wheels 16, 18.

FIG. 2C illustrates an exemplary configuration of the brake drum-type electric parking brake mechanisms 34, 36, 38 built in the brake disks of the rear-left wheel brake mechanism 24 and the rear-right wheel brake mechanism 26.

More specifically, the parking brake mechanisms 34, 36 have the brake drums that are provided in the hat positioned at the center of the brake disks of the rear-left wheel brake mechanism 24 and the rear-right wheel brake mechanism 26, and rotate together with the wheels; and the brake shoes provided inside the individual brake disks, and is movable between the pressing position and the non-pressing position relative to the brake drum while being powered by the electric actuator for parking. The parking control unit 38 is configured integrally with each of the parking brake mechanisms 34, 36.

In the normal state (non-braking state for parking), the brake shoe is energized towards the inner circumference of the brake drum, and is kept at the non-pressing position away from the drums. Between one end of the brake shoe and one end of the brake shoe, a motor with a linear motion mechanism is attached.

When the motor of the drum-type parking rotates, the brake shoe is pushed on one end while mediated by a linear motion mechanism. When the brake shoe is pressed, it moves towards the outer circumference of the brake drum, and comes into the pressing position relative to the brake drum.

In this way, when operating the parking brake, the parking control unit 38 activates the electric actuator for parking so as to move the brake shoes of the parking brake mechanisms 34, 36 to the pressing position relative to the brake drum, thereby the braking force is applied to the rear-left/right wheels 16, 18.

Next, a control process in case of failure of the electric brake device 10 will be explained.

In general, if three out of the four wheels 12, 14, 16, 18 become unbrakable (only one wheel remains brakable), the braking operation may off-balance the vehicle, and may tend to turn it to an unintentional direction.

The electric brake device 10 uses three control units 28, 30, 32 to control four brake mechanisms 20, 22, 24, 26 provided to four wheels 12, 14, 16, 18, and in case of failure of two of these control units, three wheels will become uncontrollable, and thereby the vehicle may be off-balanced.

For this reason, in case of braking malfunction of any of the front-left wheel, the front-right wheel, the rear-left wheel and the rear-right wheel, and even in case of failure of any one of, or two control units out of the three control units 28, 30, 32, the electric brake device 10 is designed to leave at least two wheels brakable, so as to keep the steering performance of the vehicle, and so as to reserve a level of braking force necessary to stop the vehicle.

Note that, in this embodiment, failure of the control units 28, 30, 32 means the state that they cannot activate the brake mechanisms 20, 22, 24, 26, and is exemplified by failure of the power source circuit, and signal wire breakage.

Besides those described above, also failure of the brake mechanisms 20, 22, 24, 26, such as failure of the electric actuator and wear of the brake pad, may result in malfunction in wheel braking. Control policies described below will be adoptable for these cases.

FIG. 4 to FIG. 7 are explanatory drawings illustrating changes in the braking force in case of failure of the control unit.

Note that, in FIG. 4 to FIG. 7, ECU1 corresponds to the front-left wheel control unit 28, ECU2 to the front-right wheel control unit 30, ECU3 to the rear-left/right wheel control unit 32, and EPB to the parking control unit 38, respectively. FR1 corresponds to the front-left wheel brake mechanism 20, FR2 to the front-right wheel brake mechanism 22, RR1 to the rear-left wheel brake mechanism 24, and RR2 to the rear-right wheel brake mechanism 26, respectively.

In the description below, the phrase stating that “the control unit increases (or reduces) the braking force of the brake mechanism” discusses, for example, the magnitude of control exerted from the subject control unit to the brake mechanism, and does not always identify the braking force of the brake mechanism as a whole.

More specifically, for the case where the brake mechanism is controlled by a plurality of control units, even increase in the braking force given by one control unit will not always increase the braking force of the brake mechanism as a whole, typically due to failure of other control units.

First, an exemplary case where one of the control units for front wheels (the front-left wheel control unit 28 in FIG. 4) went into failure, illustrated in FIG. 4A, will be explained.

As illustrated in FIG. 4B, at the initial time T0 when the failure not yet occurred, both of the front-left wheel brake mechanism 20 and the front-right wheel brake mechanism 22 (FR1, 2) brake the front-left/right wheels 12, 14 with predetermined braking force P1; and, both of the rear-left wheel brake mechanism 24 and the rear-right wheel brake mechanism 26 (RR1, 2) brake the rear-left/right wheels 16, 18 with predetermined braking force P2 (<P1), where the braking force totals P3.

If the front-left wheel control unit 28 (ECU1) went into failure at time T1, the front-left wheel brake mechanism 20 (FR1) becomes inoperable, and the braking force of the front-left wheel brake mechanism 20 falls to zero.

In this case, the rear-left/right wheel control unit 32 reduces the braking force of the rear-right wheel brake mechanism 26 (RR2), and increases the braking force of the rear-left wheel brake mechanism 24 (RR1). The front-right wheel control unit 30 increases the braking force of the front-right wheel brake mechanism 22 (FR2).

In other words, the braking force of the rear-right wheel brake mechanism 26 positioned diagonal to the defective front-left wheel brake mechanism 20 is reduced to stabilize the vehicle posture, and the braking force of the residual brake mechanisms 22, 24 is increased, to thereby reserve a sufficient level of total braking force.

Note that, in case of failure of the front-right wheel control unit 30, it suffices to replace, in the description above, the term “front-left wheel control unit 28” with “front-right wheel control unit 30”, and the term “front-left wheel brake mechanism 20” with “front-right wheel brake mechanism 22”, respectively.

In other words, when either the front-left wheel control unit 28 or the front-right wheel control unit 30 went into failure, the rear-left/right wheel control unit 32 reduces the braking force of the rear wheel braking mechanism positioned opposite to such one defective control unit in the crosswise direction, and increases the braking force of the rear wheel braking mechanism positioned on the same side with the one defective control unit in the crosswise direction, meanwhile the other one of the front-left wheel control unit 28 and the front-right wheel control unit 30 increases the braking force of the front wheel braking mechanism positioned opposite to the one defective control unit in the crosswise direction.

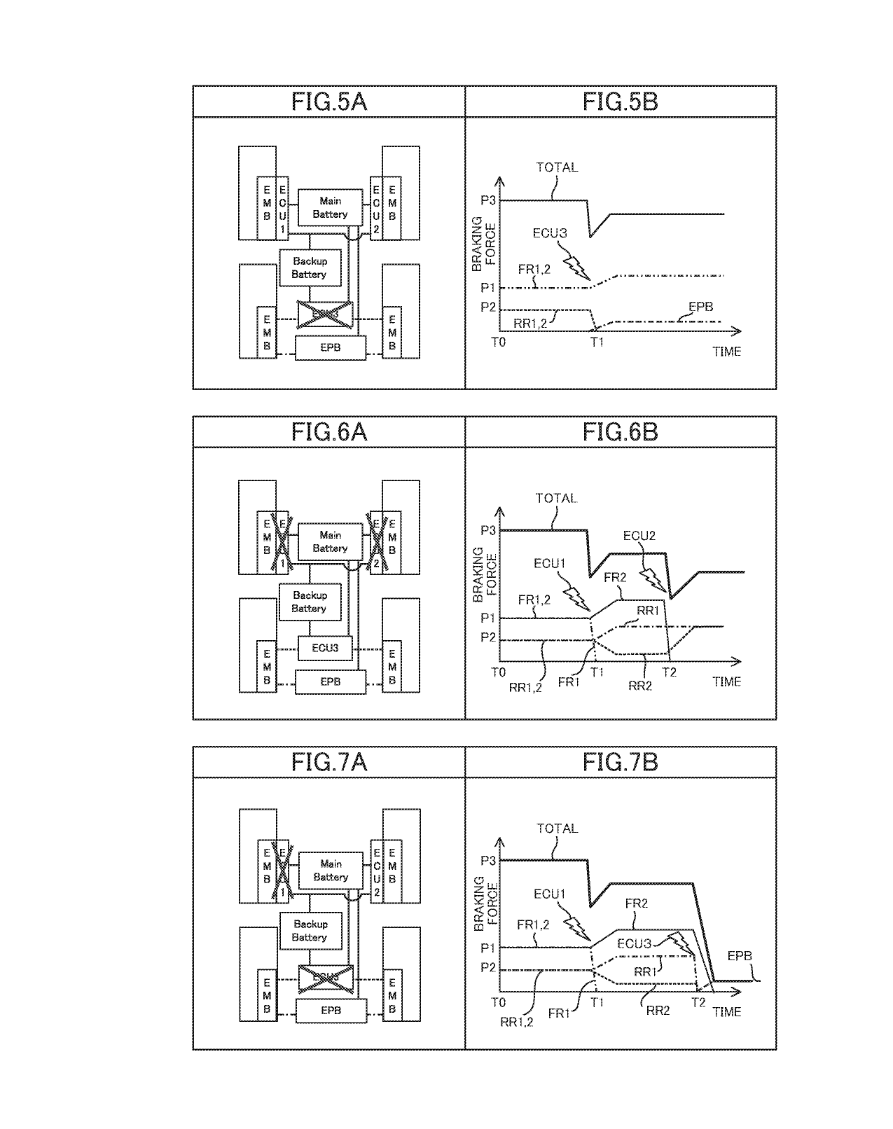

Next, an exemplary case of failure of the rear-left/right wheel control unit 32, illustrated in FIG. 5A, will be explained.

As illustrated in FIG. 5B, at the initial time T0 when the failure not yet occurs, both of the front-left wheel brake mechanism 20 and the front-right wheel brake mechanism 22 (FR1, 2) brake the front-left/right wheels 12, 14 with predetermined braking force P1; and, both of the rear-left wheel brake mechanism 24 and the rear-right wheel brake mechanism 26 (RR1, 2) brake the rear-left/right wheels 16, 18 with predetermined braking force P2 (<P 1), where the braking force totals P3.

If the rear-left/right wheel control unit 32 (ECU3) went into failure at time T1, the rear-left wheel brake mechanism 24 (RR1) and the rear-right wheel brake mechanism 26 (RR2) becomes inoperable, and the braking force of the rear wheel braking mechanisms 24, 26 falls to zero.

In this case, the front-left wheel control unit 28 and the front-right wheel control unit 30 increase the braking force of the front-left wheel brake mechanism 20 and the front-right wheel brake mechanism 22 (FR1, 2), respectively. The parking control unit 38 activates the parking brake mechanisms 34, 36 to brake the rear wheels 16, 18.

Although the braking force of the parking brake mechanisms 34, 36 is smaller than those of the rear-left wheel brake mechanism 24 and the rear-right wheel brake mechanism 26 that are service brakes, it can provide a certain level of braking force to the rear wheels 16, 18, and thereby a higher level of braking force may be obtained.

In other words, in case of failure of the rear-left/right wheel control unit 32, the front-left wheel control unit 28 and the front-left wheel control unit 30 increase the braking force of the front-left wheel brake mechanism 20 and the front-right wheel brake mechanism 22, respectively. In case of failure of the rear-left/right wheel control unit 32, the parking control unit 38 activates the parking brake mechanisms 34, 36 to generate the braking force for the rear-left wheel 16 and the rear-right wheel 18.

Note that, in general, the braking force of the front wheel braking mechanism is set larger than that of the rear wheel braking mechanism (ideal braking force distribution). Therefore, a possible option is to provide braking only by the front-left wheel brake mechanism 20 and the front-right wheel brake mechanism 22, without activating the parking brake mechanisms 34, 36. However, activation of the parking brake mechanisms 34, 36 so as to apply the braking force to the front and rear of the vehicle makes it possible to stabilize the vehicle posture, and to effectively obtain a higher level of braking force.

Next, an exemplary case where both of the front wheel control units (front-left wheel control unit 28 and the front-right wheel control unit 30) successively went into failure, illustrated in FIG. 6A, will be explained.

Referring to FIG. 6B, an exemplary case where the front-left wheel control unit 28 went into failure first, and the front-right wheel control unit 30 went into failure next, will be explained.

As illustrated in FIG. 6B, at the initial time T0 when the failures not yet occur, both of the front-left wheel brake mechanism 20 and the front-right wheel brake mechanism 22 (FR1, 2) brake the front-left/right wheels 12, 14 with predetermined braking force P1, and both of the rear-left wheel brake mechanism 24 and the rear-right wheel brake mechanism 26 (RR1, 2) brake the rear-left/right wheels 16, 18 with predetermined braking force P2 (<P 1), where the braking force totals P3.

When the front-left wheel control unit 28 (ECU1) went into failure at time T1, the front-left wheel brake mechanism 20 (FR1) becomes inoperable, and the braking force of the front-left wheel brake mechanism 20 falls to zero.

In this case, the rear-left/right wheel control unit 32 reduces the braking force of the rear-right wheel brake mechanism 26 (RR2), and increases the braking force of the rear-left wheel brake mechanism 24 (RR1). The front-right wheel control unit 30 increases the braking force of the front-right wheel brake mechanism 22 (FR2).

In other words, the braking force of the rear-right wheel brake mechanism 26 positioned diagonal to the defective front-left wheel brake mechanism 20 is reduced to stabilize the vehicle posture, and the braking force of the residual brake mechanisms 22, 24 is increased, to thereby reserve a sufficient level of total braking force.

Thereafter, when the front-right wheel control unit 30 (ECU2) went into failure at time T2, the front-right wheel brake mechanism 22 (FR2) becomes inoperable, and the braking force of the front-right wheel brake mechanism 22 falls to zero.

In this case, rear-left/right wheel control unit 32 elevates the braking force of the rear-right wheel brake mechanism 26 (RR2), having been lowered, so as to agree with the braking force of the rear-left wheel brake mechanism 24 (RR1). In this way, it now becomes possible to balance the braking force in the vehicle crosswise direction, and to reserve the braking force necessary for braking the vehicle by increasing the total braking force.

Note that, for the case where the front-right wheel control unit 30 went into failure first, and the front-left wheel control unit 28 went into failure next, it suffices to replace, in the description above, the term “front-left wheel control unit 28” with “front-right wheel control unit 30”, and the term “front-left wheel brake mechanism 20” with “front-right wheel brake mechanism 22”, respectively.

Next, an exemplary case where one of the front wheel control units (the front-left wheel control unit 28 or the front-right wheel control unit 30), and the rear-left/right wheel control unit 32 successively went into failure, illustrated in FIG. 7A, will be explained.

An exemplary case where the front-left wheel control unit 28 went into failure first, and the rear-left/right wheel control unit 32 went into failure next, illustrated in Referring to FIG. 7B, will be explained.

As illustrated in FIG. 7B, at the initial time T0 when the failures not yet occur, both of the front-left wheel brake mechanism 20 and the front-right wheel brake mechanism 22 (FR1, 2) brake the front-left/right wheels 12, 14 with predetermined braking force P1, and both of the rear-left wheel brake mechanism 24 and the rear-right wheel brake mechanisms 26 (RR1, 2) brake the rear-left/right wheels 16, 18 with predetermined braking force P2 (<P1), where the braking force totals P3.

When the front-left wheel control unit 28 (ECU1) went into failure at time T1, the front-left wheel brake mechanism 20 (FR1) becomes inoperable, and the braking force of the front-left wheel brake mechanism 20 falls to zero.

In this case, the rear-left/right wheel control unit 32 reduces the braking force of the rear-right wheel brake mechanism 26 (RR2), and increases the braking force of the rear-left wheel brake mechanism 24 (RR1). The front-right wheel control unit 30 increases the braking force of the front-right wheel brake mechanism 22 (FR2).

In other words, the braking force of the rear-right wheel brake mechanism 26 positioned diagonal to the defective front-left wheel brake mechanism 20 is reduced to stabilize the vehicle posture, and the braking force of the residual brake mechanisms 22, 24 is increased, to thereby reserve a sufficient level of total braking force.

Thereafter, when the rear-left/right wheel control unit 32 (ECU3) went into failure at time T2, the rear-left wheel brake mechanism 24 (RR1) and the rear-right wheel brake mechanism 26 (RR2) become inoperable, and the braking force of the rear wheel braking mechanisms 24, 26 falls to zero.

In this case, the front-right wheel control unit 30 zeros the braking force of the front-right wheel brake mechanism 22 (FR2) to stop braking of the front wheels 12, 14. This is for the purpose of preventing the vehicle posture from being off-balanced due to lateral unbalance of the braking force.

The parking control unit 38 then activates the parking brake mechanisms 34, 36 to brake the rear wheels 16, 18. Although the braking force of the parking brake mechanisms 34, 36 is smaller than those of the rear-left wheel brake mechanism 24 and the rear-right wheel brake mechanism 26 that are service brakes, it can provide a certain level of braking force to the rear wheels 16, 18.

In other words, when either the front-left wheel control unit 28 or the front-right wheel control unit 30, and also the rear-left/right wheel control unit 32 went into failure, the other one of the front-left wheel control unit 28 and the front-right wheel control unit 30 reduces the braking force of the front wheel braking mechanism positioned opposite to such one defective control unit in the crosswise direction, and the parking control unit 38 activates the parking brake mechanisms 34, 36 to generate the braking force for the rear-left wheel 16 and the rear-right wheel 18.

Now, an exemplary case where the rear-left/right wheel control unit 32 went into failure first, and one of the front wheel control units (the front-left wheel control unit 28 of the front-right wheel control unit 30) went into failure next, will be explained.

In this case, as illustrated in FIG. 5B, upon failure of the rear-left/right wheel control unit 32, both of the front-left wheel control unit 28 and the front-right wheel control unit 30 increase the braking force of the front-left wheel brake mechanism 20 and the front-right wheel brake mechanism 22 (FR1, 2), respectively. The parking control unit 38 activates the parking brake mechanisms 34, 36 to brake the rear wheels 16, 18.

Thereafter, when either one of the front wheel control units went into failure, (the other) non-defective front wheel control unit zeros the braking force of the front wheel braking mechanism to be controlled, so as to allow only the parking brake mechanisms 34, 36 to perform braking.

In short, irrespective of the order of occurrence of failures, the final state will be same as illustrated in FIG. 7.

Now, there may be still other mode of failure such that the rear-left/right wheel control unit 32 and the parking control unit 38 go into failure. In this case, it suffices to increase the braking force of the brake mechanisms 20, 22 for the front-left/right wheels, by using the front-left wheel control unit 28 and the front-right wheel control unit 30.

As has been explained above, in the electric brake device 10 of the embodiment, four brake mechanisms 20, 22, 24, 26 can be controlled by three control units 28, 30, 32, posing an advantage of reducing the quantity of parts of the electric brake device 10 and reducing the vehicle cost.

According to the electric brake device 10, the control units 28, 30 are allocated one by one to the front-left wheel brake mechanism 20 and the front-right wheel brake mechanism 22, and a single control unit 32 is allocated to the left and right brake mechanisms 24, 26 for rear wheels, so that even if one control unit should go into failure, the residual brake mechanism for the front wheel remains controllable, posing an advantage of enhancing redundancy of the front wheel brake whose importance in braking is higher.

According to the electric brake device 10, when one wheel caused malfunction to disable braking, the braking force is reduced for a wheel positioned opposite to the defective wheel both in the front-rear direction and the crosswise direction, posing an advantage of balancing the braking force in the vehicle crosswise direction, and stabilizing the vehicle posture during braking.

According to the electric brake device 10, in case of braking malfunction at any two or more wheels, the braking force is controlled so as to be balanced between braking forces of the left and right front wheels, and between braking forces of the left and right rear wheels, posing an advantage of balancing the braking force in the vehicle crosswise direction, and stabilizing the vehicle posture during braking.

According to the electric brake device 10, when either the front-left wheel control unit 28 or the front-right wheel control unit 30 went into failure and became disabled for braking, the braking force of the rear wheel braking mechanism positioned opposite to the defective control unit in the crosswise direction is reduced, the braking force of the rear wheel braking mechanism positioned on the same side with the defective control unit in the crosswise direction is increased, and the braking force of the front wheel braking mechanism positioned opposite to the defective control unit in the crosswise direction is increased, posing an advantage of balancing the braking force in the vehicle crosswise direction and stabilizing the vehicle posture, and of achieving a braking force nearly equal to that before the failure.

According to the electric brake device 10, in case of failure of the rear-left/right wheel control unit 32, the braking force both of the front-left wheel brake mechanism 20 and the front-right wheel brake mechanism 22 are increased, posing an advantage of achieving a braking force nearly equal to that before the failure, while balancing the braking force in the vehicle crosswise direction.

According to the electric brake device 10, in case of failure of the rear-left/right wheel control unit 32, the parking brake mechanisms 34, 36 are further activated to generate the braking force for the rear-left wheel 16 and the rear-right wheel 18, so that a higher level of braking force may be obtained.

According to the electric brake device 10, in case of failure of the front-left wheel control unit 28 and the front-right wheel control unit 30, the braking force of both of the rear-left wheel brake mechanism 24 and the rear-right wheel brake mechanism 26 is increased, posing an advantage of obtaining a braking force nearly equal to that before the failure, while balancing the braking force in the vehicle crosswise direction.

According to the electric brake device 10, in case of failure of either the front-left wheel control unit 28 or the front-right wheel control unit 30, and also of the rear-left/right wheel control unit 32, the braking force of the front wheel braking mechanism positioned opposite to the defective control unit in the crosswise direction is reduced, and the braking force for the rear-left wheel and the rear-right wheel is generated by the parking brake mechanisms 34, 36, posing an advantage of balancing the braking force in the vehicle crosswise direction, and stabilizing the vehicle posture during braking.

According to the electric brake device 10, the individual brake mechanisms 20, 22, 24, 26 obtain the braking force by pressing the friction-applying member, while being powered by the electric actuator, against the friction-receiving member that rotates together with the wheel, posing an advantage of improving responsiveness to the brake operation as compared with the conventional hydraulic brake, and enabling various modes of brake operation adopted to the vehicle conditions.

According to the electric brake device 10, a disk brake system with a high heat radiation performance is built by employing a brake disk as the friction-receiving member, and a brake pad as the friction-applying member, posing an advantage of improving durability of the brake mechanism.

In the electric brake device 10, if the rear-left wheel brake mechanism 24 and the rear-right wheel brake mechanism 26 are designed to also function as the parking brake mechanisms 34, 36, the device will be advantageous in terms of reducing vehicle weight and simplifying vehicle configuration, as compared with the case where a dedicated parking brake mechanism is provided.

In the electric brake device 10, if an additional brake system is provided at the center of the brake disk to configure the parking brake mechanisms 34, 36, the device will be advantageous in terms of relieving the load of the individual brake mechanisms, as compared with the case where the rear-left wheel brake mechanism 24 and the rear-right wheel brake mechanism 26 also function as the parking brake mechanisms 34, 36.

The electric brake device 10 has two batteries for supplying power to the brake mechanisms 20, 22, 24, 26, so that if the main battery 40 should go into failure, the sub-battery 42 can activate the brake mechanisms 20, 22, 24, 26, posing an advantage of improving redundancy of the brake mechanisms 20, 22, 24, 26.

In the embodiment described above, although the definition was that the four wheels of vehicle include a first wheel pair composed of a first wheel and a second wheel arranged leaving a space in between in the width direction of vehicle, and a second wheel pair composed of a third wheel and a fourth wheel arranged leaving a space in between in the width direction, and arranged leaving a space from the first wheel pair in the length direction of vehicle, where the first wheel corresponds to the front-left wheel 12, the second wheel to the front-right wheel 14, the third wheel to the rear-left wheel 16, and the fourth wheel to the rear-right wheel 18, the definition may alternatively be such that the first wheel corresponds to the rear-left wheel 16, the second wheel to the rear-right wheel 18, the third wheel to the front-left wheel 12, and the fourth wheel to the front-right wheel 14.

In this case, the brake mechanisms 24, 26 for the rear-left/right wheels 16, 18 will be controlled independently by the respective control units (first control unit, second control unit), and the brake mechanisms 20, 22 for the front-left/right wheels 12, 14 will be controlled by a single control unit (third control unit).

### REFERENCE SIGNS LIST

10 electric brake device; 12 front-left wheel; 14 front-right wheel; 16 rear-left wheel; 18 rear-right wheel; 20 front-left wheel brake mechanism; 22 front-right wheel brake mechanism; 24 rear-left wheel brake mechanism; 26 rear-right wheel brake mechanism; 28 front-left wheel control unit; 30 front-right wheel control unit; 34, 36 parking brake mechanism; 38 parking control unit; 40 main battery; 42 backup battery; 50 vehicle control unit; 52 brake pedal; 54 parking brake operating unit

1-15. (canceled)

16. An electric brake device for a vehicle that has a first wheel pair composed of a first wheel and a second wheel arranged leaving a space in between in a width direction of the vehicle, and a second wheel pair composed of a third wheel and a fourth wheel arranged leaving a space in between in the width direction, and arranged leaving a space from the first wheel pair in a length direction of the vehicle,
the electric brake device comprising at least three control units:
a first control unit that controls a first brake mechanism for braking the first wheel;
a second control unit that controls a second brake mechanism for braking the second wheel; and
a third control unit that controls a third brake mechanism for braking the third wheel, and a fourth brake mechanism for braking the fourth wheel,
a parking brake mechanism which applies braking force to each of the third wheel and the fourth wheel; and
a parking control unit that controls the parking brake mechanism,
wherein, in case of failure of the third control unit, the parking control unit activating the parking brake mechanism to generate braking force for the third wheel and the fourth wheel.

17. The electric brake device according to claim 16, wherein, in case of braking malfunction at any one of the first wheel, the second wheel, the third wheel and the fourth wheel, the control unit reduces braking force for a wheel positioned opposite to the defective wheel both in the width direction and the length direction.

18. The electric brake device according to claim 16, wherein, in case of braking malfunction at any two or more of the first wheel, the second wheel, the third wheel and the fourth wheel, the control unit controls braking forces in a manner such that the braking forces of the first wheel and the second wheel be balanced, and the braking forces of the third wheel and the fourth wheel be balanced.

19. The electric brake device according to claim 16, wherein, in case of failure of either the first control unit or the second control unit, the third control unit reduces braking force of either the third brake mechanism or the fourth brake mechanism positioned opposite to such one control unit in the width direction, and increases braking force of either the third brake mechanism or the fourth brake mechanism positioned on the same side with such one control unit in the width direction; and the other one of the first control unit and the second control unit increases braking force of the brake mechanism positioned opposite to such one control unit in the width direction.

20. The electric brake device according to claim 16, wherein, in case of failure of the third control unit, the first control unit and the second control unit increase braking forces of the first brake mechanism and the second brake mechanism, respectively.

21. The electric brake device according to claim 16,
wherein, in case of failure of the first control unit and the second control unit, the third control unit individually increases braking force of the third brake mechanism and the fourth brake mechanism.

22. The electric brake device according to claim 16, further comprising:
a parking brake mechanism that applies braking force to each of the third wheel and the fourth wheel; and
a parking control unit that controls the parking brake mechanism,
wherein, in case of failure of either the first control unit or the second control unit, and also of the third control unit, the other one of the first control unit and the second control unit reduces braking force of the brake mechanism positioned opposite to such one control unit in the width direction, and the parking control unit activates the parking brake mechanism to generate braking force for the third wheel and the fourth wheel.

23. The electric brake device according to claim 16,
wherein each of the brake mechanisms comprises a friction-receiving member that rotates together with the wheel; and a friction-applying member that moves while being powered by an electric actuator, and obtains the braking force by pressing the friction-applying member against the friction-receiving member.

24. The electric brake device according to claim 23,
wherein each of the brake mechanisms comprises a brake disk that rotates together with the wheel, and an electric caliper that has a brake pad movable between the pressing position and the non-pressing position relative to the brake disk by aid of the electric actuator.

25. The electric brake device according to claim 24,
wherein the third brake mechanism and the fourth brake mechanism also function as the parking brake mechanism, and
the parking control unit activates the parking brake by moving the brake pads of the third brake mechanism and the fourth brake mechanism to the pressing position relative to the brake disk.

26. The electric brake device according to claim 24,
wherein the parking brake mechanism comprises a brake drum that is provided in a hat positioned at the center of the brake disk of each of the third brake mechanism and the fourth brake mechanism, and is rotatable together with the wheel; and a brake shoe provided in each of the brake drums and movable between the pressing position and the non-pressing position relative to each brake drum by aid of an electric actuator for parking, and
the parking control unit activates the parking brake by moving the brake shoe of the parking brake mechanism to the pressing position relative to the brake drum.

27. The electric brake device according to claim 24,
wherein the parking brake mechanism comprises a brake drum that is provided in a hat positioned at the center of the brake disk of each of the third brake mechanism and the fourth brake mechanism, and is rotatable together with the wheel; and a brake shoe provided in each of the brake drum and movable between the pressing position and the non-pressing position relative to each brake drum by aid of a linear motion electric actuator, and
the parking control unit activates the parking brake by moving the brake shoe of the parking brake mechanism to the pressing position relative to the brake drum.

28. The electric brake device according to claim 16,
wherein each of the brake mechanisms is connected to a main battery and a backup battery that serve as power sources for controlling and activating the brake mechanisms, and, in case of main battery failure, the power source for each brake mechanism is switched to the backup battery.

29. The electric brake device according to claim 16,
wherein the first wheel is the front-left wheel, the second wheel is the front-right wheel, the third wheel is the rear-left wheel, and the fourth wheel is the rear-right wheel;
the first brake mechanism is the front-left wheel brake mechanism, the second brake mechanism is the front-right wheel brake mechanism, the third brake mechanism is the rear-left wheel brake mechanism, and the fourth brake mechanism is the rear-right wheel brake mechanism; and
the first control unit is the front-left wheel control unit, the second control unit is the front-right wheel control unit, and the third control unit is the rear-left/right wheel control unit.
